(19) United States
(12) Patent Application Publication
(10) Pub. No.: US 2009/0003698 A1
(43) Pub. Date: Jan. 1, 2009

(54) SEGMENTATON OF DIGITAL IMAGES

(75) Inventors: Timothy Milward, Oxford (GB); Alistair I. Watson, Dunblane (GB); William F.G. Gallafent, Oxford (GB)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: HELIGON LIMITED, London (GB)

(21) Appl. No.: 12/109,842

(22) Filed: Apr. 25, 2008

Related U.S. Application Data
(60) Provisional application No. 60/914,221, filed on Apr. 26, 2007.

(51) Int. Cl. G06K 9/34

(52) U.S. Cl. 382/171

(57) ABSTRACT

Methods and systems for segmenting a digital image are disclosed. In one embodiment, the image can be segmented based on adding parameters to the feature data of a pixel that representative of the location of the pixel. In another embodiment, the image can be divided into regions that are individually segmented and then combined together. In a further embodiment, the image can be processed to yield a rank-opened image and a rank-closed image and a new image is formed that combines the feature data of the two images together. The new image can then be segmented.

### FIELD OF THE INVENTION

The present invention relates to the manipulation of digital images, and particularly to the segmentation of digital images into segments representing different areas of the images.

### BACKGROUND OF THE INVENTION

A digital image is formed from an array of pixels. A typical digital image, produced for example by a camera, comprises a two-dimensional array of pixels forming a two-dimensional image. A volumetric data set, produced for example by a medical scanner, may be used to generate a three-dimensional image. If a time sequence of images is produced, the time parameter may be considered as an additional co-ordinate in a digital image, so that, for example, in the simplest case of a set of time-sampled one-dimensional images, the resulting image is a two-dimensional image where each row or column comprises one of the one-dimensional images sampled at a specific time. These concepts could be extended to higher dimensions.

In the field of digital image manipulation, a common task is to separate one part of an image from another part, for example to extract a foreground object from a first image in order to overlay that object on a second image, thus forming a composite image containing the foreground object of the first image with the background of the second image. Another example is the identification, in an image obtained from a satellite photograph or a medical scanner, of the areas of interest that require further scientific analysis, in order to separate them from the other areas not of interest.

An important aspect of this process is the act of identifying which pixels of the image should be extracted, and which discarded. For images containing several million pixels, representing complex areas of interest, this process can be very laborious. Professionals in the graphic design field commonly spend much of their time performing these kinds of tasks.

There exists, therefore, a need to reduce the time taken to execute these processes. One way to do this is to employ a system which performs an automatic segmentation of an image to separate the image into two or more image segments, each image segment representing a portion of the image, such as an object, or a significant part of an object in the image. For example, in an image of a person standing in front of a background, an image segment may be the portion of the image representing the whole person, or the portion of the image representing the person's jacket, trousers, hair or tie. How the image is segmented depends on the method of segmentation used and the variables controlling the segmentation.

Various methods to segment an image are described in our United States patent applications, published as US 2005/0013483, US 2006/0239548, US 2007/0031039 and US 2007/0009153, each incorporated herein by reference. Other digital image processing techniques are described in P. Soille: Morphological Image Analysis Principles and Applications, Second Edition, Publisher—Springer, incorporated herein by reference. One technique is described briefly below.

The visual characteristics of each pixel (such as colour and texture) may be defined by a set of one or more parameters, which may be referred to as ‘feature data’. For example, the colour of each pixel may be defined by a set of three values representing the components of the colour of the pixel, using a particular colour model such as the RGB or HSL model. Additional or alternative colour components may be used, for example if the image represents a multi-spectral image sampled at several wavelengths (such as, visible, x-ray, infra-red or ultra-violet). In a greyscale image, the colour may be defined by a single value representing the intensity of the pixel. The texture of the image, or the colour gradient, in the region of each pixel may also be defined by one or more values. Other visual characteristics may also be defined by further values. The parameters of the feature data are often referred to as ‘channels’ of the image.

The set of all possible visual characteristics may be represented as a set of points in an abstract space, which may be referred to in general as ‘feature space’. Where each pixel is represented by a set of n parameters, the feature space is an n-dimensional space, each dimension corresponding to one of the parameters. A specific visual characteristic is represented by the point in the feature space whose n co-ordinates are the set of values defining the visual characteristic. In a specific example, a 3-dimensional colour space may be defined such that the three co-ordinates of each point correspond to the three RGB components of the colour represented by each point. In cases where the parameters defining the visual characteristics of pixels can take only discrete values. The points representing all possible visual characteristics in the corresponding feature space will form a lattice.

In one method of segmenting an image, the feature space representing the visual characteristics of pixels in the image is first divided into separate regions, which may be referred to as ‘feature segments’. The set of visual characteristics represented by those points within a particular feature segment may be referred to as belonging to the same ‘feature class’. In the specific case where the feature space is a colour space, the set of colours represented by those points within a particular feature segment may be referred to as belonging to the same colour class. Since points within a given feature segment of the feature space generally have similar co-ordinates, the visual characteristics in the feature class corresponding to that feature segment will be similar.

One method for dividing the feature space into feature segments is described below. For each possible set of values of the n parameters, the numbers of pixels in the image having visual characteristics defined by those sets of values are determined and stored. This corresponds to generating an n-dimensional histogram in which a value is assigned to each point in feature space representing the frequency of occurrence of each visual characteristic in the image. The resulting histogram may be visualised as a n+1 dimensional surface, with the extra dimension corresponding to the frequency in each histogram bin. The Watershed algorithm is then applied to the histogram dataset to derive the feature classes.

The Watershed algorithm functions broadly as follows. For ease of visualisation, consider a two dimensional histogram represented as a three dimensional surface. Such a histogram would result from an image in which the visual characteristics of each pixel are defined by two parameters, such as hue and saturation. The x and y axis of the surface correspond to the two parameters and the z axis corresponds to the frequency. The surface generally comprises various peaks and troughs like hilly terrain.

If a plane defined by points of equal z is then lowered from a position above the highest point on the surface, eventually, the plane will intersect the surface at a point at the top of the highest peak. This point is assigned to a first feature segment. As the plane moves down further, the surface and the plane will intersect at a series of contour lines which expand from around the initial intersection point. All the points on these various contour lines are assigned to the same feature segment as the initial intersection point.

Eventually, a point at the top of another peak of the surface will intersect the plane. This point is not connected to the point at the top of the first peak by the existing series of contour lines, so this point is assigned to a different feature segment. As the plane continues to move down, contour lines continue to expand around the first point, but also a separate series of contour lines expand from around the second point. All the points on these further contour lines are assigned to the same feature segment as the point from which the contour lines expand.

This process is continued so that each time a new peak of the surface is intersected, the point at the top of that peak is assigned to a new feature segment and the contour lines which expand from that point are assigned to the same feature segment. Eventually, as the plane moves down, the contour lines of different peaks will meet, and the points at which they meet are defined as the edges of the feature segments. The x and y co-ordinates of the points at which the contours meet correspond to the edges of the regions of the original n-dimensional feature space defining the feature segments, and thus the feature classes.

Returning now to the image itself, each pixel in the image is assigned to a particular image segment according to the feature class the visual characteristic each pixel belongs to. In a first example, all those pixels having visual characteristics belonging to the same feature class are assigned to the same image segment. In the specific colour example, all pixels having colours belonging to the same colour class are assigned to the same image segment. In this case, there will be a one-to-one correspondence between image segments and feature classes. In general this will result in image segments which are non-contiguous. To prevent this, if desired, a further condition may be imposed that the image segments consist of contiguous regions of the image. When this condition is imposed, two regions of the image which comprise pixels having visual characteristics belonging to the same feature class, but which are not contiguous with each other will be assigned to different image segments. In the specific colour example, each image segment will consist of a contiguous region of pixels having colours belonging to the same colour class.

If the separation of the feature space into regions is performed appropriately, the resulting segmentation of the image will be such that the image segments produced represent visually distinct regions of the image such as individual objects (for example, a person) or distinct regions within an object (for example, the hair or trousers of a person).

Once the image segmentation is complete, a user may select one or more entire image segments, representing areas of interest, via a user interface, for example by clicking on a single pixel within the image segment. The image segmentation may be highlighted for the benefit of the user, for example by highlighting the edges of the image segments. This approach is much easier than selecting entire groups of pixels individually within an image segment. The selected image segments may then be isolated for further analysis, or overlaid onto a further image.

If the segmentation is deemed unsatisfactory, the segmentation may be repeated with different parameters. In some techniques, the automated segmentation technique described above may be refined by a manual refinement process.

We have appreciated that existing segmentation techniques often produce undesirable segmentations of images. For example, images may be over-segmented or under-segmented, and resulting segments may not represent useful regions of the image for the purpose of digital image manipulation. There is a need, therefore, for an improved method of segmentation.

### SUMMARY OF THE INVENTION

The invention is defined in the independent claims to which reference may now be directed. Preferred features are set out in the dependent claims.

In an embodiment of the invention, an image is segmented according to a first method. The digital image comprises pixels whose visual characteristics are defined by feature data comprising N parameters. Additional parameters are added to the feature data of each pixel, the additional parameters representing the position of each pixel within the image. The possible sets of values of the expanded feature data (comprising the original parameters plus additional spatial parameters) are divided into expanded feature classes. This may be achieved, for example, by applying the Watershed algorithm to the histogram derived from the expanded feature data of the image. Each pixel of the image is assigned to an image segment according to which expanded feature class the visual characteristics of each pixel belongs to. In one embodiment, all pixels having visual characteristics within the same expanded feature class are assigned to the same image segment. By including additional spatial parameters in the feature data, two object in the image which are widely separated in the image, but which have similar visual characteristics are likely to be assigned to different image segments.

In one embodiment, the additional parameters represent the co-ordinates of each pixel in the image. In another embodiment the additional parameters represent the co-ordinates of each pixel scaled by a scaling factor. By scaling the co-ordinates to produce the additional parameter values, the sensitivity of the segmentation to the spatial separation of pixels in the image may be taken into account.

In another embodiment, an image is segmented according to a second method. The image is divided into regions, and each region is independently segmented. The separate segmentations are then combined together to produce a complete segmentation of the whole image. When a particular region is segmented, only a subset of the total pixels in the image are used to provide data used in the segmentation process. In one embodiment, the data used in the segmentation process to segment a particular region of the image is derived entirely from the set of pixels forming the region being segmented. In another embodiment, the data used in the segmentation process to segment a particular region is derived from the set of pixels forming an area containing the region being segmented, but being larger than it.

In a further embodiment, an image is processed to produce a rank-opened version of the image and a rank-closed version of the image. The rank-opened image and rank-closed image may be used, not only to derive texture data, but also to provide a segmentation in which the effects of noise present in the original image is reduced. A new image is derived by combining the feature data of the rank-opened and rank-closed images together so that each pixel in the new image comprises feature data having twice as many parameters or channels as the original image. For example, the feature data of each pixel in the new image is derived by concatenating, or otherwise combining, the feature data of the corresponding pixel in the rank-opened image with the corresponding pixel in the rank-closed image. The new image may then be segmented using any suitable technique, such as using the Watershed method.

### BRIEF DESCRIPTION OF THE FIGURES

FIG. 1 is a schematic diagram of a system allowing manipulation of digital images;

FIG. 2 shows one example of a digital image;

FIG. 3 is a flow chart of a method of segmenting an image;

FIG. 4a shows the unexpanded feature space of a one dimensional greyscale image;

FIG. 4b shows the expanded feature space of a one dimensional greyscale image;

FIG. 5 illustrates an image divided into receptive fields;

FIG. 6 illustrates the segmentation of a first receptive field in the image of FIG. 5;

FIG. 7 illustrates the segmentation of a second receptive field in the image of FIG. 5;

FIG. 8 illustrates the segmentation of each receptive field in the image of FIG. 5;

FIG. 9 illustrates the final segmentation of the image illustrated in FIG. 5;

FIG. 10 illustrates a single receptive field consisting of an area of the image, and a segmentation region consisting of sub-area of the receptive field;

FIG. 11 illustrates two overlapping receptive fields and their corresponding adjacent segmentation areas;

FIG. 12 is a graph representing a discrete image y=f(x);

FIG. 13 is a histogram based on the image of FIG. 12;

FIG. 14 is a graph representing a continuous image;

FIG. 15 shows various examples of discrete images and their corresponding histograms; and

FIG. 16 shows a flow chart representing the process of segmenting the image according to one embodiment of the invention.

### DETAILED DESCRIPTION OF PREFERRED EMBODIMENTS

The present invention provides a system and method for segmenting a digital image. Segmenting an image means separating the image into different areas, referred to herein as image segments. An image segment is thus a defined region of an image comprising a set of pixels. This allows the pixels in one image segment to be isolated from the other pixels in the image so that, for example, the pixels in the isolated image segment can be modified independently of the other pixels, or extracted from the image and overlaid onto another image.

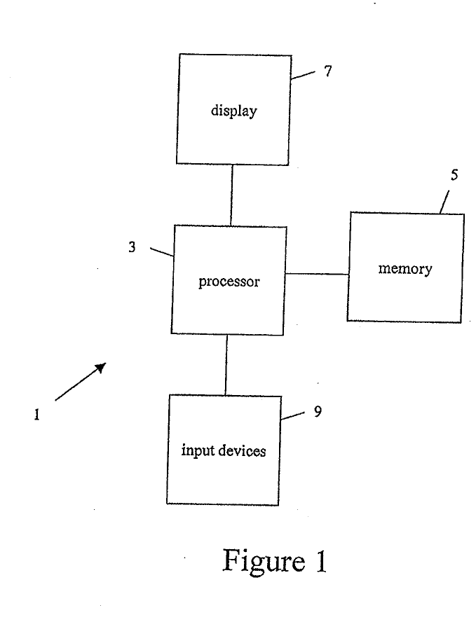

FIG. 1 is a schematic diagram of a system allowing manipulation of digital images. The system 1 comprises a processor 3, a memory 5, a display 7 and one or more input devices 9. The processor is arranged to execute digital image manipulation software and to perform various operations involved in the image manipulation. The software, digital images and other data may be stored in the memory 5. The digital images may be displayed to a user on the display 7, which may be a standard video monitor for example. The digital images are presented in a user interface which may provide facilities to allow the user to select pixels and areas of the image, and to perform various operations by selecting icons. The user interface may also provide facilities to display information to the user following various operations, such as illustrating the segmentation of the image.

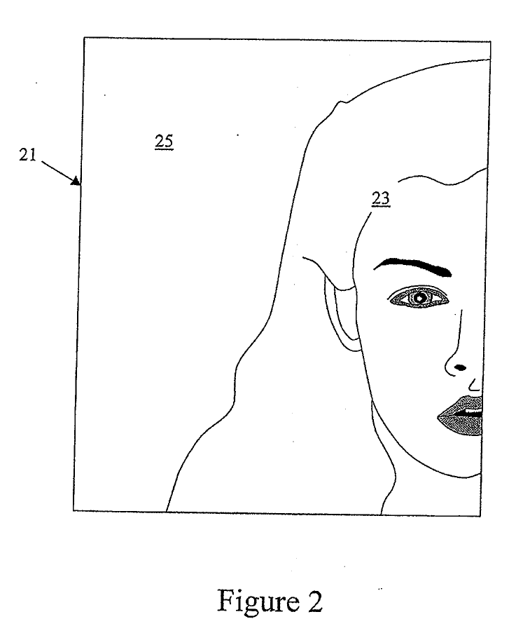

A digital image may be loaded and displayed to the user by selecting the appropriate icon in the user interface and selecting the desired image from one or more image files stored in the memory. FIG. 2 shows one example of a digital image, which is a portion of a face against a background. The image 21 may be segmented in order to divide the image into areas of interest. For example, the image may be segmented to separate the foreground face portion (including the hair) 23 of the image from the background portion 25 so that the face can be extracted and overlaid onto a new background. In this case, the most suitable segmentation is one which produces a set of image segments, a subset of which represents the entire foreground 23, but not the background 25. For example, a single image segment representing the entire face portion may be defined, or a series of image segments representing the eyes, nose, mouth, face, hair, and so on, which together represent the entire foreground 23. These foreground image segments may then be selected for processing. Upon the user selecting the appropriate icon, the processor proceeds to analyse the image to perform the segmentation.

### Additional Parameters

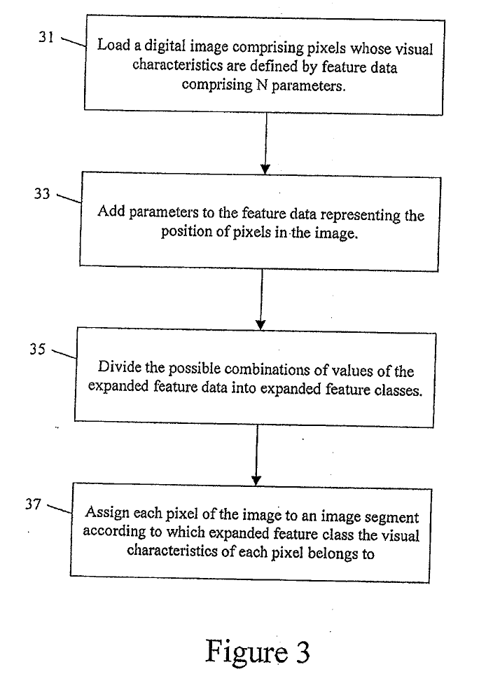

FIG. 3 is a flow chart of a first method of segmenting an image.

In a first step 31a digital image is loaded. The digital image comprises pixels whose visual characteristics are defined by feature data comprising N parameters.

In a next step 33, additional parameters are added to the feature data of each pixel, the additional parameters representing the position of each pixel within the image. The resulting feature data, including the original parameters and additional parameters, may be referred to as expanded feature data. By adding additional parameters to the feature data, the dimensionality of the feature space of the image is increased by an amount equal to the number of parameters added. The resulting feature space may be referred to as expanded feature space. The feature space is then segmented according to any suitable method using the expanded feature data. For example, the Watershed algorithm is applied to the histogram dataset derived from the image based on the expanded feature data.

As mentioned above, the visual characteristics of each pixel are defined by a set of feature data consisting of n parameters, the values of the parameters defining the visual characteristic of a pixel. In the example described below, there are three parameters, R, G and B, which represent the three RGB components of the colour of each pixel. Additional parameters are added to the feature data which represent the position of a pixel within the image. In the example described below, the image is a two dimensional image and so two additional parameters, X and Y, are added to the feature data representing the x and y co-ordinates of the position of the pixel within the image. Thus, each pixel has associated with it five values {R, G, B, X, Y}.

In a next step 35, the possible sets of values of the expanded set of parameters are divided into expanded feature classes, for example by applying the Watershed algorithm to the histogram derived from the expanded feature data. After this step, any particular set of values of the expanded feature data {R, G, B, X, Y} will be assigned to a specific expanded feature class.

In a next step 37, each pixel of the image is assigned to an image segment according to which expanded feature class the visual characteristics of each pixel belongs to. In particular, all pixels having visual characteristics within the same expanded feature class are assigned to the same image segment.

It can be seen that, using the technique described above, two pixels which are widely spaced in the image are less likely to be assigned to the same image segment, even if their visual characteristics are similar, than two closely spaced pixels having similar visual characteristics. This is because, since the additional parameters in the expanded feature data relate to the position of pixels, two pixels which are widely spaced in image space will have expanded feature data represented respectively by points which are widely separated in the expanded feature space. The points are more likely to be assigned to different feature classes and therefore the pixels are more likely to be assigned to different image segments.

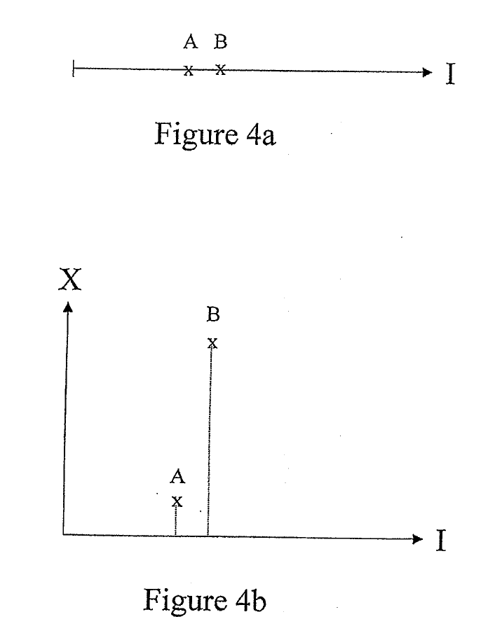

This principle is illustrated in FIGS. 4a and 4b which respectively show the unexpanded and expanded feature spaces of a one dimensional greyscale image. The unexpanded feature data in this example comprises a single parameter, I, representing the intensity of a pixel, and, as illustrated in FIG. 4a, the feature space may be represented by a one-dimensional space (a line). Two similar intensities would be represented by two closely spaced points, A and B, in the feature space, likely to be assigned to the same feature segment. When an additional spatial parameter X, representing the x co-ordinate in the one-dimensional image, is added to the feature data, the feature space expands to become a two-dimensional space a illustrated in FIG. 4b. The extended feature data of two pixels having similar intensities, but which are widely spaced in the image, would be represented by the two points A and B illustrated in FIG. 4b. Although these points remain closely spaced in the I direction, they are widely spaced in the X direction, resulting in them being widely spaced overall.

In one embodiment, the additional parameters, such as X and Y, represent up or down scaled versions of the co-ordinates of pixels in the image. For example, if a scaling factor of 0.5 is used, a pixel having co-ordinates of (10, 5) would have scaled co-ordinates of (5, 2.5). The scaled co-ordinates may be constrained to be integers, for example by taking the integer part of the scaled co-ordinates, so that, in the preceding example, the pixel would have downscaled co-ordinates of (5,2). In this case, if the scaling factors in the x and y directions are p and q respectively, the number of pixels having the same downscaled co-ordinates would be (1/p)×(1/q) (if p<1 and q<1). The amount by which the co-ordinates are scaled may be a parameter within the system which may be selected either by the user or automatically by the system. Different scaling factors may be applied to each of the spatial dimensions. By scaling the co-ordinates to produce the additional parameter values, the sensitivity of the segmentation to the spatial separation of pixels in the image may be taken into account. For example, increasing the scaling factor will reduce the chances that pixels in the image having similar visual characteristics, but which are spatially separated in the image, will be assigned to the same image segment. Similarly, decreasing the scaling factor will increase the chances that pixels in the image having similar visual characteristics, but which are spatially separated in the image, will be assigned to the same image segment. Using a scaling factor of zero will eliminate the effect of introducing the additional spatial parameters in the feature data. A scaling factor may also be used to scale the other feature values, as well as those in the spatial channels. In the same way as for the spatial channels, a smaller scaling factor for a given feature channel will reduce the influence that channel has over the classification, a larger factor increases it. Again, a scaling factor of 0 means that the channel is completely ignored.

It may be desirable that objects within the image which have similar visual characteristics, but which are widely spaced in the image are assigned to the same image segment. This can be achieved by decreasing the scaling factor. On the other hand, it may be desirable that widely spaced objects in the image are not assigned to the same image segment, even if they have similar visual characteristics. This can be achieved by increasing the scaling factor.

The segmentation technique described above provides a greater degree of control as to how objects and regions of an image are assigned to image segments since the degree to which spatial separation of objects affects the segmentation can be controlled. Thus, an improved segmentation of an image may be achieved. Also, by including spatial parameters in the feature data, it is easier to control the segmentation such that separate objects in the image are assigned to different image segments. This means that it is not required to impose constraints on the segmentation to ensure that image segments are contiguous, as required by existing methods. The addition of spatial parameters in the feature data automatically separates distinct (i.e. spatially separate) objects into different image segments, even if they are visually similar, thereby increasing efficiency of segmentation.

### Receptive Fields

According to a second method of segmenting an image, the image is divided into regions, and each region is independently segmented. The separate segmentations are then combined together to produce a complete segmentation of the whole image. When a particular region is segmented, only a subset of the total pixels in the image are used to provide data used in the segmentation process. In one embodiment, the data used in the segmentation process to segment a particular region of the image may be derived entirely from the set of pixels forming the region being segmented. In another embodiment, the data used in the segmentation process to segment a particular region may be derived from the set of pixels forming an area containing the region being segmented, but being larger than it.

In order to segment a region of the image, a receptive field may be defined, consisting of a subset of pixels in the image and containing the region to be segmented. The pixels forming the receptive field provide the data used in the segmentation process. As discussed in greater detail below, the receptive field may be larger than the region being segmented. However, in the first example described below, the region being segmented is the same as the region of pixels of the receptive field.

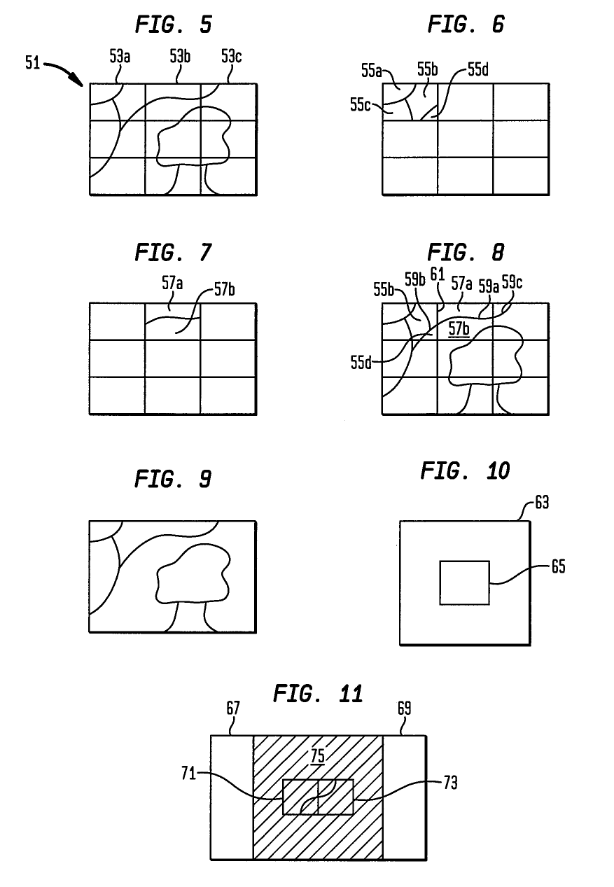

FIG. 5 illustrates an image 51 divided into receptive fields 53a, 53b, 53c, which in this example are mutually exclusive portions of the image. In one embodiment, each receptive field comprises a square region of the image, 32 pixels wide and 32 pixels high although other shapes and sizes of receptive fields may also be used. The pixels of a particular receptive field 53a are considered in isolation from the other pixels in the image. The region of the image defined by the receptive field is segmented according to any suitable method, using data derived only from pixels in the receptive field, to derive image segments within the receptive field. For example, the Watershed algorithm applied to feature space (either with or without the additional special parameters described above), may be used, or any other suitable segmentation technique. In the Watershed-based methods described above, the histogram data on which the Watershed algorithm is applied is derived only from the pixels in the receptive field currently being processed. This may be thought of as being equivalent to considering the receptive field as a separate sub-image and segmenting that sub-image. FIG. 6 illustrates the image of FIG. 5, in which the receptive field in the top left corner of the image has been segmented to produce image segments 55a, 55b, 55c.

The region of the image defined by the next receptive field 53b is then segmented to generate image segments 57a, 57b as illustrated in FIG. 7. The other receptive fields are also segmented to generate further image segments. Sufficient receptive fields are defined such that the receptive fields together cover the area of the image requiring segmentation. FIG. 8 illustrates the image segments generated for each receptive field.

Next, the individual segmentations of the receptive fields are combined together to derive a full segmentation of the complete image. In order to achieve this, the edges of the image segments in a receptive field which terminate at the edges of the receptive field are matched with the edges of image segments in adjacent receptive fields which terminate at the common border between the receptive fields. For example, in FIG. 8, image segment edge 59a in receptive field 53b is matched with image segment edges 59b and 59c in adjacent receptive fields 53a and 53c. This process is performed for all of the receptive fields so that all of the image segment edges are matched with corresponding image segment edges in adjacent receptive fields. The edges of image segments which are matched are combined to derive an image segment edge for the whole image.

Image segment edges in adjacent receptive fields may be considered to match up if the points at which they terminate at the common boundary between the receptive fields are sufficiently close. For example, referring to FIG. 8, the image segment edges 59a and 59b may be considered to match if the point at which image segment edge 59a terminates on receptive field boundary 61 is sufficiently close to the point at which image segment edge 59b terminates on the boundary 61.

In a second method to match image segment edges, the visual characteristics of pixels on one or both sides of an image segment edge in one receptive field may be compared with the visual characteristics of pixels on corresponding sides of a potential matching image segment edge in an adjacent receptive field. The image segment edges may then be considered to match if the visual characteristics of pixels on corresponding sides of the image segment edges are sufficiently similar. For example, referring to FIG. 8, the image segment edges 59a and 59b may be considered to match if the visual characteristics of image segment 57a are sufficiently close to the visual characteristics of image segment 55b, and the visual characteristics of image segment 57b are sufficiently close to the visual characteristics of image segment 55d.

Any suitable combination of methods may be used to properly match up the edges of the image segments of separate receptive fields, including those described above. Due to the nature of the technique, there tends to be good connectivity between the image segment edges in adjacent receptive fields. Techniques for improving the connectivity are described in greater detail below.

Once the image segment edges of individual receptive fields have been combined to derive the image segment edges for the complete image, the image segments for the complete image are then defined by the image segment edges. These image segments represent the final segmentation of the image. FIG. 9 illustrates the final segmentation of the image illustrated in FIG. 5.

In a further embodiment, when a region of the image is separately segmented, a receptive field is defined so that the region to be segmented is a subset of the pixels defining the receptive field. In this case, the receptive field is larger than the region being segmented, so the data used in the segmentation process is derived not only from pixels in the region being segmented, but also from pixels surrounding that region. This increases the likelihood that segment boundaries in a given segmented area match those in an adjacent segmented area, because of the overlap between the data sets used to construct the segmentations in adjacent areas.

FIG. 10 illustrates a single receptive field 63 consisting of an area of the image, and a segmentation region 65 consisting of sub-area of the receptive field. The receptive field is the area of the image containing pixels from which data used in the segmentation process is derived. The sub-area of the receptive field is the actual region of the image to be segmented using this receptive field. The segmentation region of the receptive field may consist of the central area of the receptive field for example. Various sizes and positions of the segmentation areas relative to the sizes and positions of the receptive fields may be used. These sizes and positions may be specified as parameters within the system.

The region of the image defined by the segmentation area is segmented using any suitable technique, based of data derived from the whole receptive field. For example, if the Watershed-based methods described above are used, the histogram data on which the Watershed algorithm is applied is derived from the pixels in the receptive field. However, only pixels within the segmentation area are assigned to image segments.

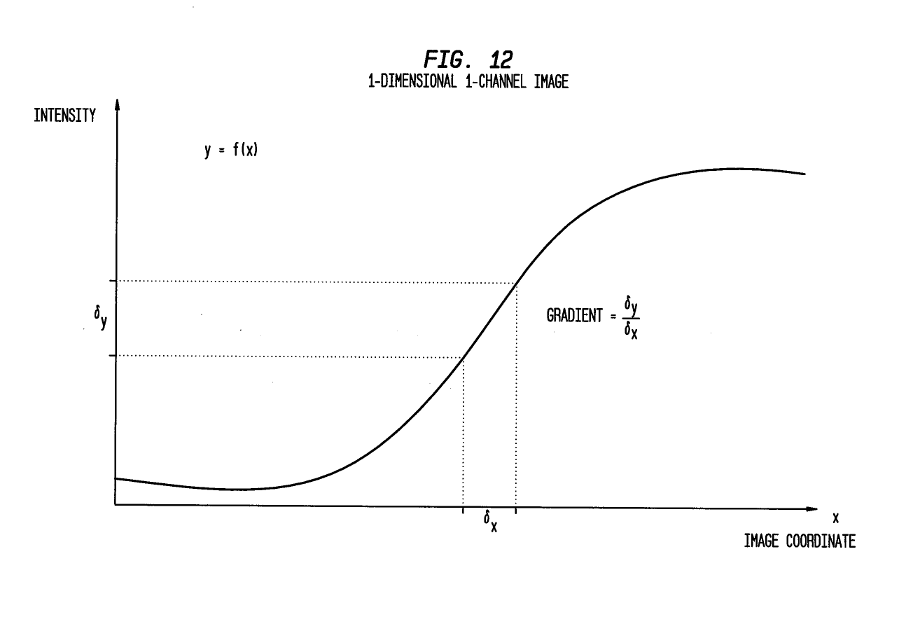

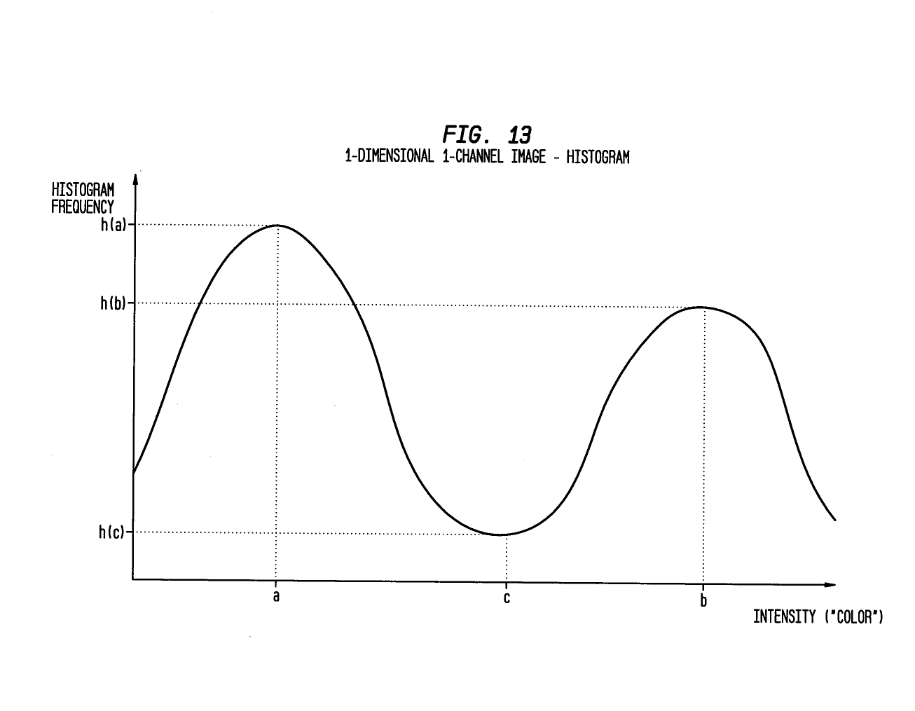

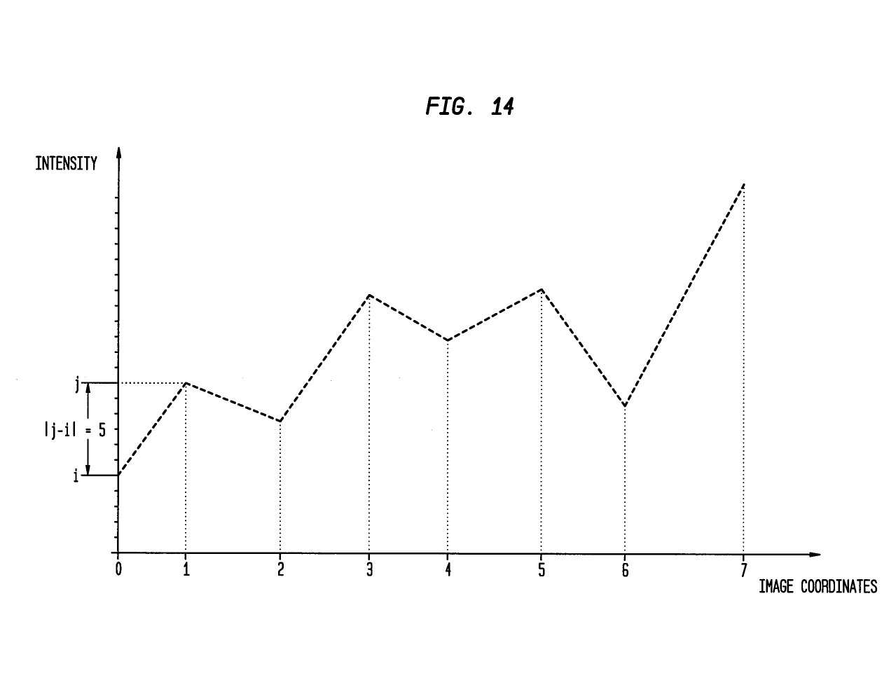

The segmentation areas of further receptive fields are then segmented. The receptive fields are defined such that the corresponding segmentation areas, when combined, cover the area of the image requiring segmentation. FIG. 11 illustrates two receptive fields 67, 69 and their corresponding segmentation areas 71, 73, the receptive fields being defined such that the respective segmentation areas are adjacent. Since the segmentation areas are smaller than the size of the receptive fields, in order that two segmentation areas are adjacent, the corresponding receptive fields are displaced by a distance smaller than the size of the receptive fields. Therefore, the two receptive fields overlap, and in particular there is some overlap of the pixel feature data from which the segmentation of each segmentation area is derived. For example, in FIG. 11, the grey area 75 consists of pixels whose feature data is used to derive the segmentations of both segmentation areas 71 and 73. For this reason, there is a more even continuity between the data used to segment adjacent segmentation areas, which results in better connectivity between the image segments of adjacent segmentation areas. In general, as the size of the segmentation areas relative to the size of the receptive fields decreases, a better connectivity of the individual image segments of adjacent segmentation areas is achieved, although a greater number of receptive fields are required to cover the same area of the image, thus increasing computation.

By using overlapping receptive fields and segmenting only a sub-area of each, over-segmentation of the complete image is avoided. In many images, the visual characteristics can change significantly over different regions of the image. Therefore, pixel data in a first and second regions of the image may be significantly different, and so including pixel data from the first region in calculations to segment the second region may distort the results of the segmentation. In the technique described above, segmentation of relatively small regions of the image are performed on the basis of data derived only from pixels in the vicinity of a region being segmented. Therefore, pixel data from parts of the image distant from the region being segmented, which could distort the results of the segmentation, are not used in the segmentation calculations. This means that a more reliable segmentation of the image is produced.

In another embodiment, the histogram, and corresponding feature-space classification, built for each region of the image is not used to segment the image directly in this way, but to generate a further data set for each region. The classification data sets for all regions are then used to create a single data set corresponding to the whole image, which is used to perform the segmentation of the image.

The key feature of this embodiment is its use of a measure of the gradient of the image, which is a measure at each pixel of the rate of change of the feature-vector as you move away from that pixel in image-space. To calculate the gradient (dy/dx) of a discrete image, y=f (x), (FIG. 12) consider it an approximation of a continuous function. By definition, the histogram of a discrete function, y=f (x), where x and y are integers, measures the frequency of a single value of y, so dy=1. The histogram measure is the number of pixels with colour y, which is equal to dx (assuming that f is invertible, which is true for “local” histograms, which cover a sufficiently small area of an image). Since dx=histogram value, and dy=1, the histogram value is dx=dx/dy=1/gradient. So we can estimate the gradient of an image at a pixel from the reciprocal of the local histogram value for the colour of the pixel.

After building the histogram for each receptive field, it is classified using, for example, the watershed algorithm in feature space. This produces a set of classes for each region. This watershed might be carried out in the N-dimensional feature space of the image, or it might be that several 1-dimensional watersheds are executed, one for each channel in the image. The latter method allows for useful efficiency and quality improvements in the implementation: by simultaneously performing a 1D watershed with a mask+marker morphological reconstruction, the classification is tolerant of noise, and it is possible to control the level of detail (number of classes produced) of the segmentation. Further implementation details allow this 1D watershed to be carried out in a single pass over the histogram data set, with execution taking linear (order n) time, rather than the usual order (n log n) time, which is useful in applying this approach to large data sets.

The final segmentation is to be created by running a watershed algorithm over a data set which is a graph consisting of nodes, corresponding to pixels, and edges, corresponding to connections between adjacent pixels. With reference to FIG. 13 X, the value for each node (pixel) is the histogram value for the modal feature-vector of the class to which the pixel belongs, according to its colour, e.g. hₐ for a pixel in class A. The value for each edge between two pixels is either the same value hₐ, if the two pixels belong to the same class A, or is the histogram value for the lowest point in the histogram between the two classes, h_{c} if the pixels belong to different classes A and B. When the watershed algorithm is run on this graph, boundaries between segments are therefore likely to be found between pixels which are of different classes, due to the lower values found on these edges compared to those on edges between pixels of the same class. The relative difference between hₐ, h_{b} and h_{c} in the histogram is related to a number of characteristics of the image in the local area, including but not limited to the width of the edge, the contrast (difference in colour/intensity between the two sides) of the edge, and the amount of noise in the image relative to the contrast of the edge. In the case where N 1D histograms have been created for each receptive field, rather than 1 ND histogram, each pixel will be found to have N classes (one in each channel's classification). In the same way as a multidimensional gradient is derived from the gradient in each dimension, the histogram class-mode values may be combined to give a single gradient estimate for each pixel, e.g. for a two-channel system with channels a and b, h (p, q)=1/√((1/h(p))²+(1/h (q))²) where h (p) and h (q) are the histogram value of the class found for the pixel in the classification for channel p and channel q respectively.

The graph thus created is segmented using a mask+marker watershed algorithm, simultaneously performing reconstruction by dilation, extended to operate on a graph structure, where the mask corresponds to the edges of the graph, and the marker to the nodes.

In order to achieve a smooth variation in the values assigned to nodes and edges in the graph, avoiding discontinuities at the boundaries between receptive fields, the estimate calculated for the four nearest receptive fields may be weighted-averaged according to the position of the pixel. An alternative approach which achieves this smoothness is to calculate a histogram (and classification, thus class modes and gradient estimates) for each pixel, using a receptive field which is centred on that pixel. This means that a different histogram is used for each pixel, but that these histograms tend to vary smoothly as you move from one pixel to the next. This technique allows for a reduction in memory use, since the storage for one receptive field only is required. By using an algorithm to calculate a 1D histogram for each pixel which takes linear time (order n) when operating over several pixels (by taking advantage of the fact that most of the pixels sampled in a receptive field centred on a given pixel are the same as those sampled in the receptive field centred on a nearby pixel), this approach may also be taken without using excessive computational time.

### Sparse Histogram

In some of the techniques described above, a problem can occur in that the histogram data used to segment the image may be too sparse. For example, if there are n parameters in the feature data, each of which can each take one of m values, then the total number of possible set of values of the parameters, and therefore possible visual characteristics is mⁿ. An image which is p pixels wide and q pixels high, comprises p×q pixels, and at most, p×q different visual characteristics. In some cases, mⁿ may exceed p×q by a significant factor. For example, with 3 parameters representing colour components which can take one of 256 values, there are 256³≈16.8 million possible sets of values, and hence possible colours. A 1024×1024 pixel image comprises around a million pixels, so at most, there will be around a million different visual characteristics in the image (if each pixel has a different visual characteristic). Therefore, in this case, there are at least 16 times as many possible visual characteristics as there are actual visual characteristics present in the image. Therefore, the histogram bins may be sparsely populated depending on the actual distribution of visual characteristics in the image. This problem is exacerbated when more parameters are added to the feature data, which increases the number of possible visual characteristics. This problem is reduced by down-scaling feature values, but this loses too much information about the image, particularly when the number of pixels being sampled is relatively small.

If further parameters are added to the feature data representing the co-ordinates of a pixel, then since there is only one pixel with a particular set of co-ordinates, there can be, at most, only one pixel having a particular set of values for the expanded feature data. Each bin in the resulting histogram in the expanded feature space will therefore have a value of one at most, with most bins having the value zero. This problem is reduced if the additional parameters represent downscaled versions of the co-ordinates, since in this case, there will be multiple pixels having the same downscaled coordinates. In particular, sparsity will be a problem if any given channel of the feature data is not sufficiently downscaled. Each channel of the feature space will often be scaled down by a certain amount in order to achieve good density in the histogram, even when the number of pixels being sampled is large.

In the segmentation technique involving receptive fields described above, as the size of the receptive fields decreases, the number of pixels which contribute to the histogram data also decreases. In some cases, the size of the receptive fields may be so small that the resulting histogram bins are sparsely populated.

In cases where histogram data is sparse, the resulting image segmentation may be inadequate. However, the problems associated with sparsely populated histograms may be reduced by applying any suitable technique to reduce the sparsity.

The sparsity of local histograms in particular may cause noise to affect adversely the quality of the gradient estimates used in some embodiments of the invention. This problem may be overcome in a number of ways. For example, the histogram may be smoothed directly, for example by convolving with a gaussian, but this operates on the distribution without reference to the geometry of the image: without a knowledge of the width and contrast of edges, choosing the correct gaussian to smooth out noise without removing genuine features of the data is difficult. Another example approach involves enlarging the image to reduce the sparsity (by increasing the number of pixels being sampled), assuming that the original image samples a continuous “true image”, and interpolating between sampled pixel values accordingly; since memory and processing demands increase as the pixel count increases, such methods tend to be prohibitively slow. A further example approach is to treat the image as an approximation of a continuous function, and to compute the histogram of a continuous function directly, without the need to generate the enlarged image. This latter example is described in detail below.

### Interpolated Histograms

In order to generate histograms which contain the data for a pair of pixels which is equivalent to that which would be generated from an hypothetical continuous image of the same scene (FIG. 14), simply add the constant value max (1, 1/|j-i|) to every bin in the histogram in the range [i,j] inclusive. The total cumulative amount added to the histogram for each pixel remains the same (=1) as for the non-interpolated case.

Depending on the type of computer hardware used to implement this approach, it may be appropriate to use a fixed-point representation for the histogram values, in order to improve performance compared to the use of a real-valued representation.

The actual interpolated image is never built, and the addition of a constant (which itself is very fast to calculate) to a continuous set of bins in a histogram is fast, making this approach computationally viable.

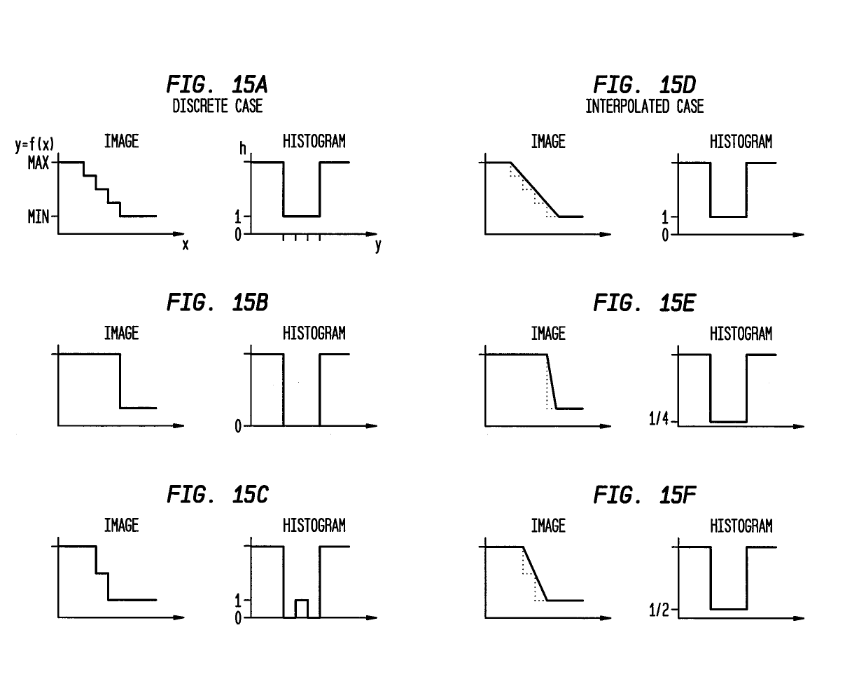

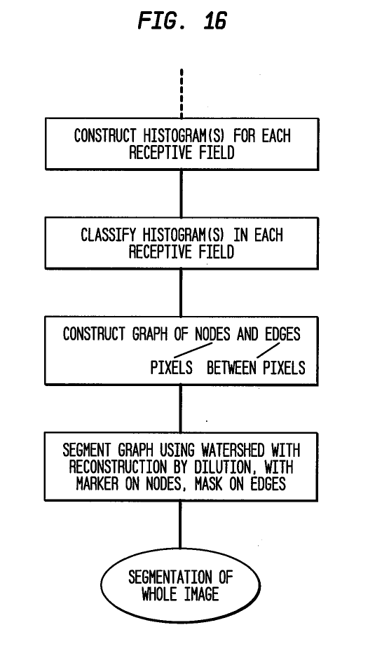

It is important, when constructing histograms which will be classified, that a sufficient amount of data is present that every intermediate intensity/colour between two “object” colours is represented. In FIGS. 15a, 15b and 15c show examples of discrete images: 15a shows a shallow edge with sufficient data to find two classes, 15b a sharp edge with two well defined classes, but 15c an edge with an intermediate gradient, for which three classes will be found, one corresponding to an intensity between the two true classes, because its entry in the histogram is not connected to either, due to insufficient resolution of the discrete image. FIGS. 15d, 15e and 15f show the same images' histogram results when the histograms are calculated using the interpolated-histogram approach, demonstrating that the correct shape is always built, allowing the true classes to be found, without the quantization artifacts due to the discretization of the image adversely affecting the classification. Note that the histograms in FIGS. 15a and 15d are identical, because when the discrete image contains enough data that changes in y are only +/−1 for each change of +/−1 in x, the “correct” histogram may be constructed directly; it is only when this is not the case (often, with real image data) that the interpolated method produces better results.

### Rank Opening/Closing

It is often desirable to derive information representative of the texture of an image in the area surrounding each pixel in the image. In one technique, a greyscale rank-opening filter and a greyscale rank-closing filter is applied to each channel of the input image (each channel being one of the parameters in the feature data). The rank-opening process generates an image in which light features are accentuated and the rank-closing process generates an image in which dark features are accentuated. In more textured areas, where there is greater variation between nearby pixels, the difference between the rank-opened and rank-closed image will be greater than for smoother areas of the image. Therefore, the data representing the rank-opened and rank-closed images, taken together, provides information about the texture of the image at each pixel. For example, the difference in feature data between the rank-opened image and rank-closed image at each pixel provides a simple measurement of the degree of texture at each pixel.

In a typical image, noise present within the image may result in unsatisfactory segmentation. For example, the image may be over-segmented, where too many image segments are derived. The image segments in an over-segmented image do not necessarily represent logical visual elements of the image, but can represent variations within the image caused by noise.

In an embodiment of the present invention, the rank-opening and rank-closing process is used, not only to derive texture data, but also to provide a segmentation in which the effects of noise present in the original image is reduced.

In order to produce a rank-opened version of an image, the following process is performed for each pixel in the image. This process consists of a rank erosion, followed by a rank dilation. To perform the rank erosion, the set of pixels in an area (the processing area) surrounding the current pixel being processed (the candidate pixel) are considered. The area may be, for example, a square shaped area of 32 by 32 pixels surrounding the candidate pixel, although other shapes and sizes of structuring element could be used. The pixels in the processing area are ranked in order of the values of the first parameter in the feature data. For example, in the case that the visual characteristics of each pixel are defined by three colour components, RGB, the pixels in the processing area are ranked in order of the value of the first colour component, R. A pixel at a specific position in the ordered set of pixels is then selected. In particular, a pixel which occurs at a certain position below the median pixel is selected. In one embodiment, for example, the pixel at the 10th percentile is selected, although pixels at other positions may be selected. In some embodiments, the position at which a pixel is selected is a parameter within the system which may be set either automatically by the system, or by a user. Then, the value of the first parameter of the selected pixel is chosen as the value of the first parameter of the pixel in the rank-closed image corresponding to the candidate pixel.

The preceding process is repeated with respect to the candidate pixel for each of the other parameters in the feature data to generate a series of parameter values for the pixel in the rank-eroded image corresponding to the candidate pixel. For each parameter, the position in the ordered set of pixels at which a pixel is selected may be different, or may be the same for each parameter. Next, the above process is repeated for each pixel in the image. Each time a pixel is processed in this way, the original image data, and not data modified by preceding pixel processing, is used.

After this rank erosion process has been carried out for every pixel in the image, a rank dilation is applied to the rank-eroded image in each channel. This follows the same approach as the rank erosion, except that instead of choosing the nth percentile pixel in the ordered set as the value for the dilated image, the (100-n)th percentile pixel is chosen. The resulting rank-opened image is thus the result of the application of two functions sequentially: rank-dilation (rank-erosion (original image)).

After this process has been carried out, the visual characteristics of the pixel in the rank-opened version of the image corresponding to the candidate pixel in the original image will be determined.

After this process has been carried out, the resulting pixels form the rank-opened version of the original image.

In order to produce a rank-closed version of the original image, a similar process to the rank-opening process is performed except that the order of application of the two functions (rank-erosion and rank-dilation) is reversed, so that the rank-closed image=rank-dilation (rank-erosion (original image)). First, to perform a rank dilation of the image, the pixels in the processing area around a candidate pixel are ranked in order of the values of the first parameter in the feature data. A pixel which occurs at a certain position above the median pixel in the ordered set of pixels (such as the 90th percentile for example) is selected. As before, the position at which a pixel is selected may be a parameter within the system. Then, the value of the first parameter of the selected pixel is chosen as the value of the first parameter of the pixel in the rank-dilated image corresponding to the candidate pixel.

The preceding process is repeated with respect to the candidate pixel for each of the other parameters in the feature data to generate a series of parameter values for the pixel in the rank-dilated image corresponding to the candidate pixel. Next, the above process is repeated for each pixel in the image.

After this rank-dilated image has been produced, the rank-erosion procedure (as described above) is applied to each pixel in the rank-dilated image, the output of which is the final rank-closed image.

In the processes described above, pixels within an area surrounding a candidate pixel are ranked in order of the values of a parameter in the feature data. In such an ordered set of pixels, it is the outlying pixels, being those which lie within the top or bottom few percentiles of the ordered set of pixels, which tend to be most affected by sampling noise present within the image. By selecting a pixel at a position in the order that is not within the top or bottom few percentiles to derive the rank-opened and rank-closed, those pixels most likely to be affected by noise are implicitly discarded. Therefore, the rank-opened and rank-closed images are less affected by the sampling noise.

In order to obtain a segmentation of the original image in which the effects of noise have been reduced, either the rank-opened or rank-closed images may be segmented instead of the original image. In many cases, segmenting the rank-opened or rank-closed images individually may not produce an entirely accurate segmentation. However, a new image, the same size as the original image, and derived from the rank-opened and rank-closed images, may be produced to produce a better segmentation. The new image is derived by combining the feature data of the rank-opened and rank-closed images together so that each pixel in the new image comprises feature data having twice as many parameters as the original image. For example, the feature data of each pixel in the new image is derived by concatenating, or otherwise combining, the feature data of the corresponding pixel in the rank-opened image with the corresponding pixel in the rank-closed image.

The new image is then segmented using any suitable technique, such as one of those described above. For example, the feature space of the new image may be segmented using the Watershed algorithm to derive feature classes and then the image segmented by assigning each pixel to an image segment according to which feature class the set of parameter values of each pixel belongs to. The feature data of each pixel in the new image comprises twice as many parameters as the feature data of each pixel in the original image. Therefore, the feature space of the new image will have a dimensionality twice as big as that of the feature space of the original image. The resulting segmentation will represent an accurate segmentation of the original image, but with the effects of noise reduced.

Since many applications of digital image processing require both the derivation of texture data, and reduction of noise, the technique described above may be used to perform these two processes in a single step, rather than requiring different processes for production of texture information and noise reduction. This significantly increases the efficiency of image processing.

Other methods of generating texture data, or of generating other image data for each pixel according to a measure of each pixel's visual characteristics and those of nearby pixels may be used. For example, if it is desirable to extract particular features in the image, filters using special structuring elements designed to locate those features may be used. One way to do this is to perform a rank-opening or a rank-closing operation using a specific template structuring element, whose shape is designed to resemble a generic version of the feature being sought. One problem which may be observed in the rank-opened and rank-closed images is that sharp corners are “smoothed off”, the amount of smoothing being dependent on the size of the structuring element used to perform the opening or closing. By performing a morphological reconstruction on the rank-opened and rank-closed images, this sharp-corner detail may be reproduced in these images, allowing a more accurate segmentation corresponding to the original image to be created from the rank-filtered images.

1. A method for segmenting a digital image, the digital image comprising pixels whose visual characteristics are defined by feature data associated with each pixel comprising a set of N parameters, the method comprising the steps of:
adding parameters to the feature data of each pixel to derive expanded feature data for each pixel, the additional parameters being representative of the location of each pixel within the image;
segmenting the feature space of the image based on the expanded feature data;
assigning visual characteristics to feature classes based on the segmentation of the feature space; and
segmenting the digital image on the basis of the segmentation of the feature space.

2. A method according to claim 1 in which the additional parameters are the co-ordinates of each pixel.

3. A method according to claim 1 in which the additional parameters are the co-ordinates of each pixel scaled by scaling factors.

4. A method according to claim 3 in which the scaling factors are modifiable.

5. A method according to claim 1 in which the feature space of the image based on the expanded feature data is segmented using the Watershed algorithm.

6. A method according to claim 1 in which the step of assigning visual characteristics to feature classes comprises the step of assigning all visual characteristics represented by points in the feature space within the same segment of feature space to the same feature class.

7. A method according to claim 1 in which the step of segmenting the digital image comprises the step of assigning pixels to image segments, in which all pixels having visual characteristics in the same feature class are assigned to the same image segment.

8. A system arranged to undertake the method of claim 1.

9. A computer readable storage medium having stored thereon program code for executing the steps of claim 1.

10. A method for segmenting a digital image, the digital image comprising pixels whose visual characteristics are defined by feature data associated with each pixel comprising a set of N parameters, the method comprising the steps of:
segmenting a segmentation region of the image based on the feature data of pixels in a data region of the image, the data region containing the segmentation region and being smaller than the entire region covered by the image;
repeating the preceding step for one or more further segmentation regions; and
combining the segmentations of the segmentations regions to derive a segmentation of the image.

11. A method according to claim 10 in which the segmentation region is the same size as the data region.

12. A method according to claim 10 in which the segmentation region is larger than the data region.

13. A method according to claim 10 in which the size of each data region is modifiable.

14. A method according to claim 10 in which the size of each segmentation region is modifiable.

15. A method according to claim 10 in which the segmentation region is an area at the centre of the data region.

16. A method according to claim 10 in which sufficient segmentation regions are segmented to cover the entire area of the image requiring segmentation.

17. A method according to claim 10 in which the step of combining the segmentations comprises the step of matching the edges of image segments in one segmentation region to corresponding edges of image segments in adjacent segmentation regions.

18. A method according to claim 17 in which the step of matching image segment edges comprises the step of matching two image segment edges in adjacent segmentation areas if the points at which the edges terminate at the common boundary between the segmentation regions are less than a predetermined distance apart.

19. A method according to claim 17 in which the step of matching image segment edges comprises the step of matching two image segment edges in adjacent segmentation areas if the visual characteristics of pixels on corresponding sides of the image segment edges are sufficiently similar.

20. A method according to claim 10 in which the segmentation is performed using the Watershed algorithm.

21. A system arranged to undertake the method of claim 10.

22. A computer readable storage medium having stored thereon program code for executing the steps of claim 10.

23. A method for segmenting a digital image, the digital image comprising pixels whose visual characteristics are defined by feature data associated with each pixel comprising a set of N parameters, the method comprising the steps of:
generating a rank-opened version of the image;
generating a rank-closed version of the image;
producing a second digital image in which the feature data of each pixel in the second image is derived by combining the feature data of the corresponding pixel in the rank-opened image with the corresponding pixel in the rank-closed image; and
segmenting the second image;

24. A method according to claim 23 in which the second image is segmented using the Watershed algorithm.

25. A method according to claim 23 in which the step of generating a rank-opened version of the image comprises the steps of:
selecting a candidate pixel in the image;
ranking a set of pixels in an area including the candidate pixel in order of the value of a first parameter in the feature data;
selecting a pixel which occurs at a certain position above the median pixel in the ordered set of pixels;
determining the value of the first parameter in the feature data of the selected pixel;
setting the value of the first parameter of a pixel in the rank-opened image corresponding to the candidate pixel to the value of the first parameter of the selected pixel.

26. A method according to claim 25 in which the pixel which occurs at a certain position above the median pixel is a pixel at a position between the 51st and 90th percentile.

27. A method according to claim 23 in which the step of generating a rank-closed version of the image comprises the steps of:
selecting a candidate pixel in the image;
ranking a set of pixels in an area including the candidate pixel in order of the value of a first parameter in the feature data;
selecting a pixel which occurs at a certain position below the median pixel in the ordered set of pixels;
determining the value of the first parameter in the feature data of the selected pixel;
setting the value of the first parameter of a pixel in the rank-opened image corresponding to the candidate pixel to the value of the first parameter of the selected pixel.

28. A method according to claim 25 in which the pixel which occurs at a certain position below the median pixel is a pixel at a position between the 1st and 49th percentile.

29. A system arranged to undertake the method of claim 23.

30. A computer readable storage medium having stored thereon program code for executing the steps of claim 23.
